(19) United States
(12) Patent Application Publication
(10) Pub. No.: US 2011/0077891 A1
(43) Pub. Date: Mar. 31, 2011

(54) ACCELEROMETER-ONLY CALIBRATION METHOD

(75) Inventor: Michael KOENIG, Irvine, CA (US)

(73) Assignee: SiRF TECHNOLOGY HOLDINGS, INC., San Jose, CA (US)

(21) Appl. No.: 12/567,478

(22) Filed: Sep. 25, 2009

(51) Int. Cl. G06F 19/00; G01C 21/00

(52) U.S. Cl. 702/104; 701/200

(57) ABSTRACT

Methods for calibrating an accelerometer without needing to use external assistance signals, such as GNSS signals. The invention is applicable to accelerometers generally—in both GPS navigation devices and other devices. A method of calibrating an accelerometer, the accelerometer having a bias, comprises: rotating the accelerometer, wherein the orientation of the axis of the accelerometer changes with respect to the local gravity vector; collecting accelerometer measurements as the accelerometer is moving; and calculating the bias and/or scale factor; wherein the accelerometer measurements are primarily due to local gravity. Furthermore, some embodiments of the present invention include a self-calibration process—a process that does not engage the user's attention. For example, in a self-calibration process for an accelerometer in a cell phone the moving step may be the movement of the phone out of a user's pocket to hold it up to view the screen.

### FIELD OF THE INVENTION

The present invention is related to calibration of accelerometers, and more particularly to an efficient calibration method without external aiding.

### BACKGROUND OF THE INVENTION

Global Navigation Satellite Systems (GNSS), such as the Global Positioning System (GPS), have some limitations such as the availability of a sufficient number of satellite signals. Satellite signals are sometimes not available in deep canyons, in areas with large numbers of buildings blocking the direct satellite signals, and in dense forest areas. In addition to this, the satellite signals can be completely blocked or greatly attenuated inside buildings. Furthermore, tunnels and bridges can block satellite signals resulting in large jumps in the indicated position at the exit of the tunnel after new satellite signals are received. To reduce these errors, other complementary methods are often used with satellite navigational systems to prevent interruptions in the position information. For example, inertial measurement units (IMUs) such as gyroscopes and accelerometers may be used to measure changes in direction and acceleration. IMUs may be incorporated in a very wide range of satellite based navigation systems—e.g. personal navigation devices (PNDs), other hand held devices such as cell phones, and vehicle-based navigation devices.

More particularly, after the position of a GPS receiver is initially determined, the IMUs allow the position of the receiver to be determined as the receiver moves, even if the satellite signals are blocked. The determination of the position based on measuring the receiver movement is known as dead reckoning (i.e. inertial navigation). The accuracy of a dead reckoning position, and how long it remains accurate, depends on the quality of the sensors and how well they are calibrated.

Calibration of the IMUs is required each time before starting the process of inertial navigation. Note that the prior calibration may in fact still be accurate, but that would not be known without essentially calibrating. Therefore, a calibration routine is run each time before navigation. The calibration of an accelerometer triad, for example, might include determining: the orientation of the triad relative to the gravity vector; the biases of the individual accelerometers; and scaling factors for the individual accelerometers. The calibration process needs to be efficient, since inertial navigation needs to start as soon as possible after satellite signals are lost. Furthermore, a self-calibration process—a process that does not engage the user's attention—will be preferred as a matter of user convenience and also efficiency. This means that the user is not obligated to perform a specific set of maneuvers to facilitate the calibration process.

Clearly, there is a need for an efficient method of calibrating accelerometers without needing to acquire GPS signals. Furthermore, there is a general need for an efficient method of calibrating accelerometers without needing to use any external assistance signals, where external assistance signals may be GNSS signals, WiFi signals, TV signals, signals from cell towers, LORAN (Long Range Navigation) signals and sensor signals (sensor signals including altimeter signals, compass signals, etc.). Note that here use of a signal may or may not require utilizing all or any data encoded in the signal—the signal may be used just as a ranging signal. Furthermore, there is a need for a self-calibration process for accelerometers.

Accelerometers are used in a wide variety of applications outside of GPS-based navigation—for example, accelerometers are widely used in the fields of vibration/seismic sensing, monitoring of machinery, pedestrian motion, etc. These accelerometers may also benefit from efficient methods of calibration.

### SUMMARY OF THE INVENTION

The present invention provides methods for calibrating an accelerometer—enabling the provision of unbiased measurements—without needing to use external assistance signals. External assistance signals include signals such as GNSS signals, WiFi signals, TV signals, signals from cell towers, LORAN (Long Range Navigation) signals and sensor signals (sensor signals including altimeter signals, compass signals, etc.). Furthermore, the methods do not require high data sampling rates, and do not result in large computational loads. The invention is applicable to accelerometers generally—in both GNSS navigation devices and other devices. The calibration includes determining accelerometer bias and or scale factor, where the accelerometer bias is the zero offset for accelerometer measurements and the accelerometer scale factor is the ratio of the change in output (in volts or amperes) to a unit change of the input (in units of g).

Accelerometers are commonly utilized in triads, allowing measurement of acceleration along three roughly orthogonal axes. Note that due to manufacturing limitations, the axes of a triad are ordinarily not truly orthogonal; however, this does not limit the effectiveness of the methods presented herein. The methods of the present invention can be used for calibration of accelerometer triads.

Accelerometers embedded in a device and calibrated using some embodiments of the present invention may be used to estimate: the pitch and/or roll of the device with respect to the earth; horizontal acceleration of the device—useful for navigation applications; and vertical acceleration of the device—useful for pedestrian navigation up and down stairs and elevators, for example. Note that accelerations are measured in units of g—a standard value of gravity, which on the Earth's surface is approximately 9.8 m/s². However, using a gravity table, more accurate estimates of the magnitude of the acceleration may be calculated.

According to aspects of the invention a method of calibrating an accelerometer, the accelerometer having a bias, comprises: moving the accelerometer, wherein the orientation of the axis of the accelerometer changes with respect to the local gravity vector; collecting accelerometer measurements as the accelerometer is moving; and calculating the bias; wherein the accelerometer measurements are primarily due to local gravity. Furthermore, the calculating step may further include calculating a scale factor. Furthermore, some embodiments of the present invention include a self-calibration process—a process that does not engage the user's attention. For example, in a self-calibration process for an accelerometer in a cell phone the moving step may be the movement of the phone out of a user's pocket to hold it up to view the screen.

According to further aspects of the invention a circuit for calibrating an accelerometer triad, each component accelerometer of the accelerometer triad having a bias, comprises: an analog to digital converter for converting analog accelerometer measurements from the accelerometer triad to digital accelerometer measurements; a power routine processor block for weighting each of the digital accelerometer measurements by an estimated noise power; and a bias estimate processor block for calculating the biases from weighted digital accelerometer measurements.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a representation of a portable navigation device or cell phone showing the axes of an accelerometer triad embedded within said device;

FIG. 2 is a flow chart of a basic method for calibrating an accelerometer according to some embodiments of the present invention;

FIG. 3A is a representation of a portable navigation device or cell phone being calibrated according to some embodiments of the present invention;

FIG. 3B is a plot of calibration points corresponding to the calibration process of FIG. 3A when the device is rotated slowly and smoothly;

FIG. 3C is a plot of calibration points corresponding to the calibration process of FIG. 3A when the device rotation is non-ideal;

FIG. 4 is a schematic diagram of a circuit for calibrating an accelerometer, according to some embodiments of the present invention;

FIG. 5 is a “Gravity Ellipsoid” generated according to some embodiments of the present invention;

FIG. 6 is a graph of accelerometer bias estimates, showing the rate of convergence, according to some embodiments of the present invention;

FIGS. 7A and 7B are graphs of accelerometer bias and scaling estimates, showing the rate of convergence, according to some embodiments of the present invention; and

FIGS. 8A & 8B show 3-dimensional calibration plots, according to some embodiments of the present invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

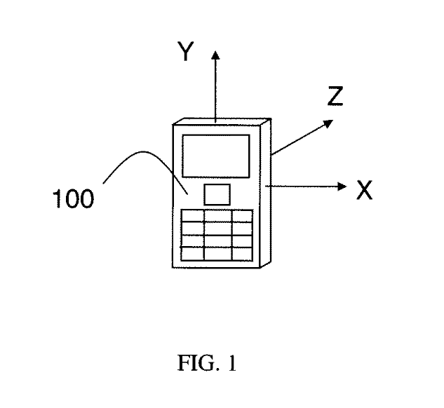

For purposes of illustration of aspects of the invention the calibration of an accelerometer triad attached to a platform, embedded in a navigation device (with a GPS receiver) or cell phone 100, is described and shown in FIG. 1. For simplicity, the axes of the accelerometers are assumed to correspond to the Cartesian coordinate axes X, Y and Z. Note that due to manufacturing limitations, the axes of a triad are ordinarily not truly orthogonal; however, this does not limit the effectiveness of the methods presented herein. Furthermore, the methods of the invention are not limited to calibration of such accelerometer triads, but may also be applied to other accelerometer configurations, as will be apparent to those skilled in the art after reading this description.

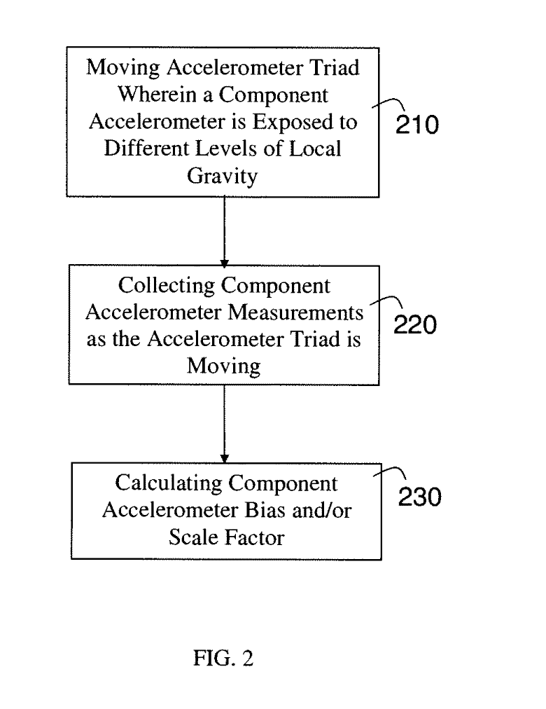

The basic method according to embodiments of the present invention for calibrating an accelerometer in an accelerometer triad is shown in FIG. 2. The accelerometer triad must be moved such that each accelerometer is exposed to different levels of local gravity (210), for example by tilting and rotating the triad. Accelerometer measurements are collected while the accelerometer triad is being moved (220). The movement is preferably a smooth rotation to minimize the amount of translation related acceleration in the measurements (which obstructs the resolution of biases and scale factors); although, less smooth and slow motion may be accommodated by some embodiments of the present invention, as described below. The accelerometer bias and/or scale factor is calculated (230). The accelerometer bias is the zero offset for accelerometer measurements and the accelerometer scale factor is the ratio of the change in output (in volts or amperes) to a unit change of the input (in units of g).

The basic method for calibrating an accelerometer in an accelerometer triad, as described above and shown in FIG. 2, may be implemented using the following hardware: (1) an accelerometer triad, (2) an analog-to-digital converter, (3) a sampler, (4) and a central processor with algorithms coded in software running on the central processor. In some embodiments, (3) and (4) may be combined on a single chip. The central processor may have a dedicated port/connector it will sample when commanded, or it may have some kind of standard data bus that connects to a sampler, which itself has dedicated ports and hardware buffers. All of the hardware components (1)-(5) are generally integrated into a single device, such as the navigation device 100 in FIG. 1. These components may be used as follows, Analog signals generated by an accelerometer in the accelerometer triad are converted to digital signals by the analog-to-digital converter. The digital signal is then sampled by the sampler and the sampled signal is processed by the central processor. The algorithms coded in software running on the central processor are used to process the sampled signal and generate accelerometer bias and/or scale factor data.

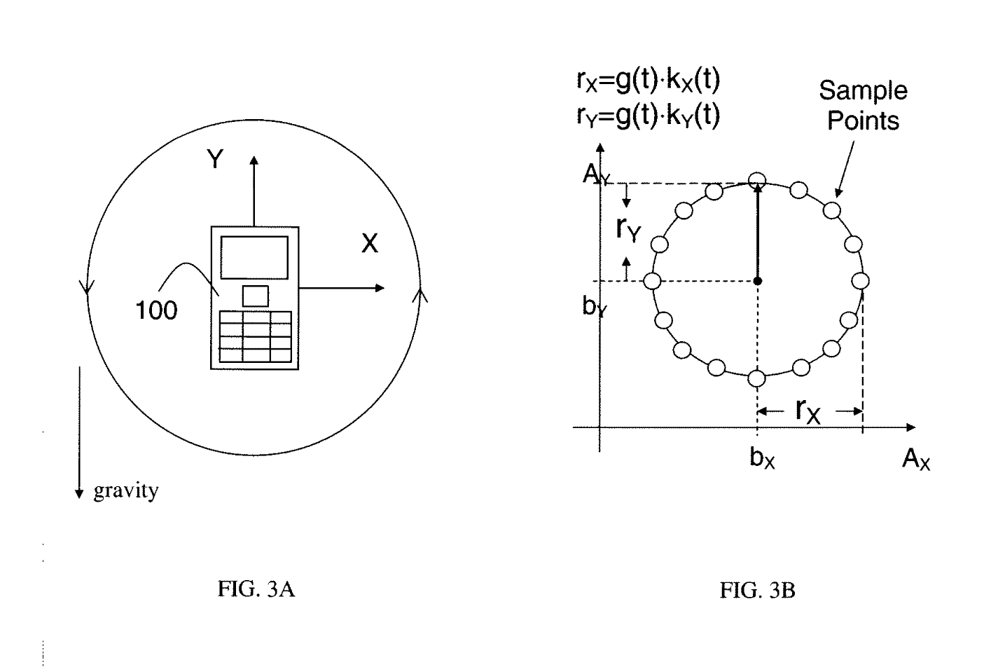

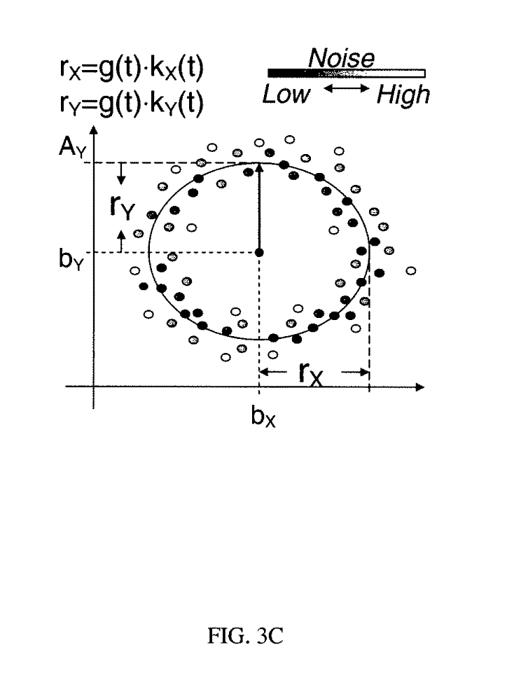

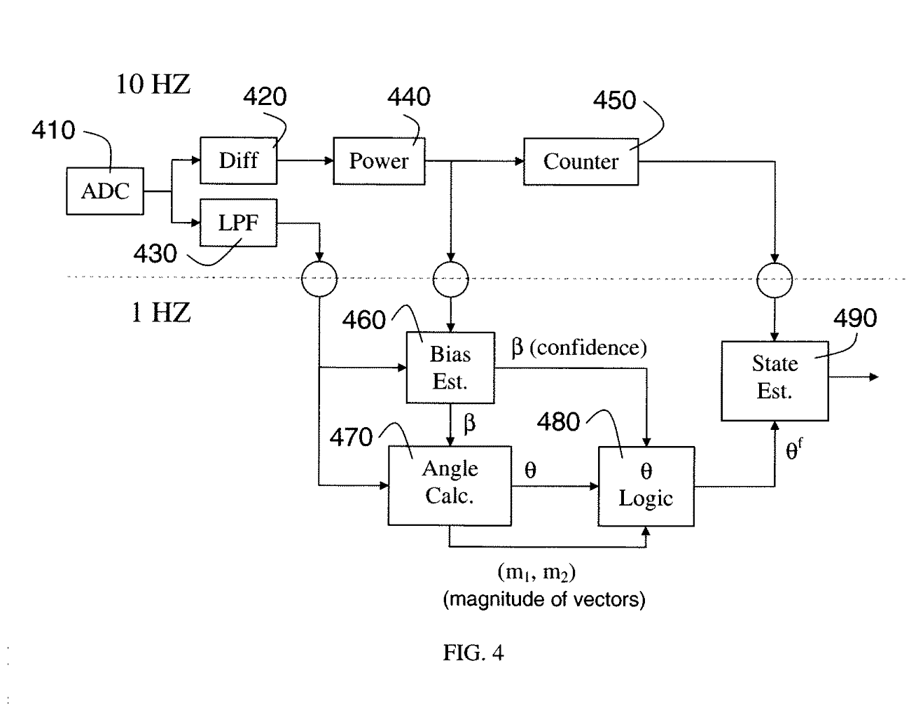

FIGS. 3A and 3B illustrate an ideal motion in 2 dimensions for calibrating accelerometers. In FIG. 3A the GPS device 100 is shown being rotated in a vertical plane, which contains the gravity vector. The axes X and Y are the axes of two accelerometers. The device 100 is rotated slowly so that the accelerometer axes X and Y remain within the vertical plane. The rotation is smooth and slow so as to provide insignificant acceleration relative to local gravity. (It is found that noise due to device acceleration of 0.01 g is easily tolerated—allowing meaningful calibration data to be extracted. Furthermore, device acceleration up to approximately 0.1 g may also be tolerated, as discussed in more detail below.) Accelerometer measurements Aₓ and A_{y} are collected at intervals as the device 100 is rotated. In FIG. 3B, sample points of accelerometer measurements Aₓ and A_{y} are plotted. The plot is an ellipse centered at (bₓ, b_{y}). When the scaling factors for the two accelerometers are the same, the plot will be a circle. The radii rₓ and t_{y} are represented by equations:

r_{X}=g(t)·k_{X}(t) (1)

r_{Y}=g(t)·k_{Y}(t) (2)

where g(t) is the magnitude of local gravity, and kₓ and k_{y} are parameters which scale the sampled measurements into a physical value of acceleration derived from the magnitude of local gravity. Note that kₓ and k_{y} are functions of many environmental factors which affect the accelerometers, for example temperature. As described below, measurement of the radii and center of the ellipsoid in FIG. 3B allows the accelerometer bias and scale factors to be determined.

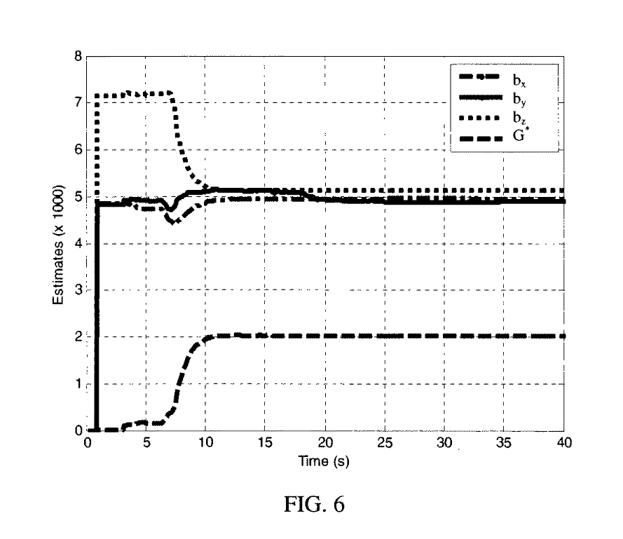

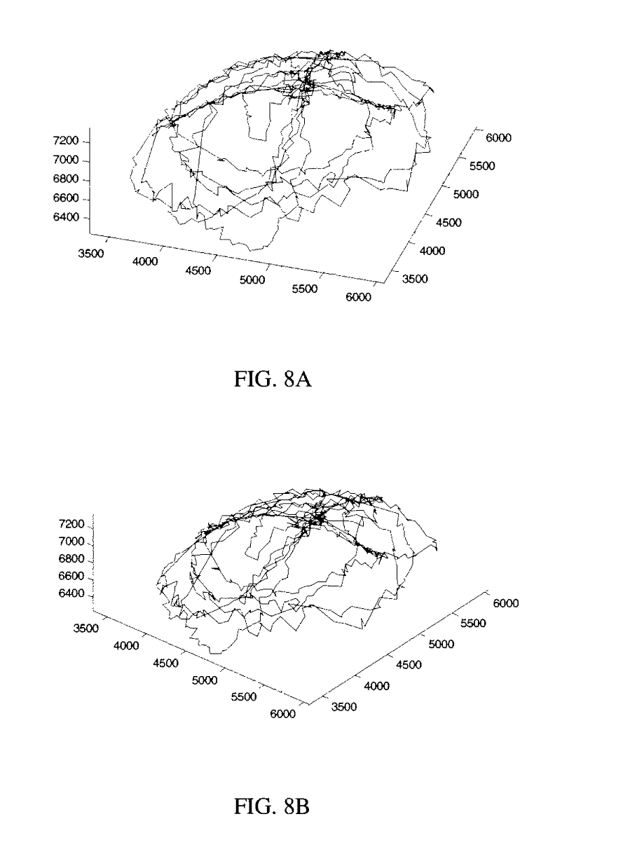

For ease of illustration, a 2 dimensional example is provided in FIGS. 3A and 3B. However, after reading this description, those skilled in the art will appreciate how this approach may be extended to 3 dimensions. Examples of measurements collected due to movement in 3 dimensions are shown in FIGS. 5, 8A and 8B.

Some embodiments of the invention are methods of self-calibration—processes that do not engage the user's attention—and will generally have need of a weighting scheme for accelerometer measurements to accommodate motion which may not always be smooth and slow. For example, embodiments of the present invention are intended to provide calibration of accelerometers using measurements taken when the device 100 is being moved by a motion such as taking a cell phone out of a pocket and holding it up to view the screen. Furthermore, embodiments of the present invention may provide calibration of accelerometers using measurements taken when the device 100 is in a user's pocket as the user is moving about.

FIG. 3C illustrates “noisy motion” for calibration of the accelerometers. “Noisy motion” is representative of the motion the user may impart to the device while the device is executing a self-calibration routine and includes accelerations which are significant when compared with local gravity. Such “noisy motion” illustrates the need for weighting data points in order to improve the calibration process. Use of weighting factors in the calibration method is described in greater detail below.

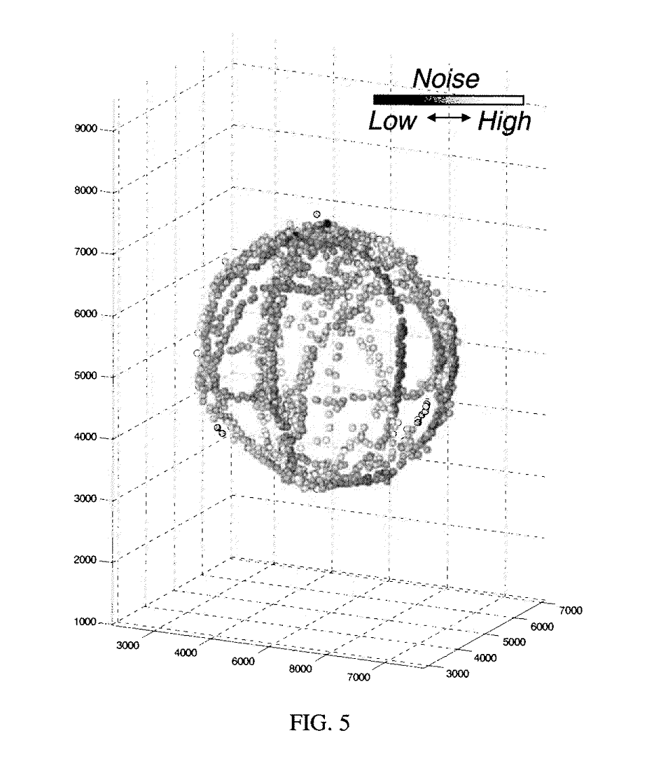

FIG. 4 is a schematic of a circuit that is used for calibrating the device 100, where the device comprises an accelerometer triad attached to a platform. In FIG. 4, measurements from the component accelerometers of the accelerometer triad are converted by an analog to digital converter 410 and then are processed by a differentiator 420 and a low pass filter (LPF) 430. A power routine processor block 440 has running on it an algorithm (coded in software) which estimates the instantaneous “power” of the system by taking the sum of squares of the one-epoch difference across all three accelerometers of the triad. Equations (9)-(11), discussed in more detail below, describe the operation of this module: the sum of the squares differences is calculated, giving an instantaneous estimate of the power (equation (9)): the power values are filtered to reduce the effect of any one data point, since this is an imperfect estimate of platform dynamism (equation (10)); the filtered power estimate is translated directly into a weight (equation (11)). Counter 450 determines how long the system has been in a certain power state. That is, if the power is low, counter 450 determines how long has it has been low. If it has been low for a while, then this is a strong indication that the platform is stationary. Bias estimate processor block 460 has running on it an algorithm (coded in software) which handles the accelerometer calibration which provides estimates of the accelerometer biases, β, and/or scale factors. Note that the accelerometer calibration is dominated by the circuit bias, or ADC sampling bias, which maps the output of the accelerometer triad (which may be from −1 to +1 V, for example) into the voltage domain of the ADC (typically 0-5 V). Angle calculation processor block 470 uses the bias estimates from block 460 to calibrate the data output from the LPF 430 to determine how much of an angle the platform has displaced in the current motion (motion since the platform was last stationary). θ logic processor block 480 estimates the current angle/orientation of the system based on the initial angle estimate (from block 470), the amount of confidence in the bias estimate, β(confidence), and the magnitude of the vectors (m₁, m₂) used to estimate the angle, the latter is also basically an estimate of confidence. State estimator processor block 490 uses the angle output of processor block 480, with the counter values from counter 450 to indicate what state of repose the platform may be in, along with any other information to make an estimate of the system's state, using a catch-all algorithm coded in software. The output from block 490 may be connected to multiple other sub-systems, as may be required. The calibration circuit shown in FIG. 4 may be on a single chip, or a combination of chips.

A more detailed mathematical description of the calibration process for an accelerometer triad is provided as follows. When the device 100 is stationary the only force acting on the accelerometers is gravity. A representative equation which describes the general constraint on the accelerometer triad is given in equation (3), and rearranged for equation (4). The values of A_{X}, A_{Y}, and A_{Z} are the measurements from the accelerometers (through the analog to digital converter (ADC)) and bₓ, b_{y} and b_{z} are the biases of the accelerometers. G is a representation of local gravity. A, b and G are measured in levels—determined by the number of bits available in the analog-to-digital convertor (ADC). Typical ADCs have roughly 13 bits, which equates to approximately 8000 levels. Equation (3) represents a spherical surface.

However, as discussed in greater detail below, the present invention is not limited to embodiments in which a spherical surface is described.

G²=(A_{X}−b_{X})²+(A_{Y}−b_{Y})²+(A_{Z}−b_{Z})² (3)

(A_{X}²+A_{Y}²+A_{Z}²)=2·(A_{X}·b_{X}+A_{Y}·b_{Y}+A_{Z}·b_{Z})+(G²−(b_{X}²+b_{Y}²+b_{Z}²)) (4)

The terms Mₙ and G* are introduced for convenience, where Mₙ, represents a form of the measurements at epoch n. (Here epoch is used to refer to a particular one of a series of times with some unspecified, but regular frequency.)

Mₙ=(A_{X,n}²+A_{Y,n}²+A_{Z,n}²) (5)

G*=G²+(b_{X}²+b_{Y}²+b_{Z}²) (6)

Equations (3)-(6) are stacked, see equation (7), and solved for the biases, see equation (8), where A^{T} is the matrix transpose of matrix A, and the matrix W is a matrix of weighting values, as described below.

$$\begin{matrix}\vert \begin{matrix}{M}_{1} \\ ⋮ \\ {M}_{n}\end{matrix} \vert = \vert \begin{matrix}2 \cdot {A}_{X , 1} & 2 \cdot {A}_{Y , 1} & 2 \cdot {A}_{Z , 1} & 1 \\ ⋮ & ⋮ & ⋮ & ⋮ \\ 2 \cdot {A}_{X , n} & 2 \cdot {A}_{Y , n} & 2 \cdot {A}_{Z , n} & 1\end{matrix} \vert \cdot \vert \begin{matrix}{b}_{X} \\ {b}_{Y} \\ {b}_{Z} \\ {G}^{*}\end{matrix} \vert = A \cdot \overline{x} & ( 7 ) \\ \vert \begin{matrix}{\hat{b}}_{X} \\ {\hat{b}}_{Y} \\ {\hat{b}}_{Z} \\ {\hat{G}}^{*}\end{matrix} \vert = {( {A}^{T} \cdot W \cdot A )}^{- 1} \cdot {A}^{T} \cdot W \cdot \overline{M} & ( 8 )\end{matrix}$$

Ideally, accelerometer measurements A_{X}, A_{Y}, and A_{Z} are collected when the platform is stationary. However, in practice measurements are often taken when the platform is still moving. To accommodate measurements taken when the platform is moving, and yet provide a reliable calibration, the measurements are weighted by an estimate of the noise power, as follows. Equations (9) & (10) define the “raw” and “filtered” noise powers rₙ and fₙ, respectively. Where τ is a filter time constant, the larger (closer to one) that τ is, the more the filter will deemphasize current measurements. This value is chosen empirically, and for FIGS. 5 through 8, τ=0.9 was used.

rₙ=(A_{X,n}−A_{X,n-1})²+(A_{Y,n}−A_{Y,n-1})²+(A_{Z,n}−A_{Z,n-1})² (9)

fₙ=τ·fₙ₋₁+(1−τrₙ (10)

Since power is best described by its order of magnitude, the log₁₀ function is used, and to avoid taking the log₁₀ of zero, one is added to the interior value, to give a weighting factor wₙ, as in Equation (11). Equation (12) defines W, the matrix of weighting values. Using equation (12), the parts of equation (8) are expanded as shown in equations (13) and (14).

$$\begin{matrix}{w}_{n} = \frac{1}{{log}_{10} ( {f}_{n} + 1 )} & ( 11 ) \\ W = \vert \begin{matrix}{w}_{1}^{2} & 0 & 0 \\ 0 & ⋱ & 0 \\ 0 & 0 & {w}_{n}^{2}\end{matrix} \vert & ( 12 ) \\ {A}^{T} \cdot W \cdot A = \vert \begin{matrix}4 {\sum }_{i = 1}^{n} {( {A}_{X , i} {w}_{i} )}^{2} & 4 {\sum }_{i = 1}^{n} {( {A}_{X , i} {A}_{Y , i} {w}_{i} )}^{2} & 4 {\sum }_{i = 1}^{n} {( {A}_{X , i} {A}_{Z , i} {w}_{i} )}^{2} & 2 {\sum }_{i = 1}^{n} ( {A}_{X , i} {w}_{i}^{2} ) \\ 4 {\sum }_{i = 1}^{n} {( {A}_{Y , i} {A}_{X , i} {w}_{i} )}^{2} & 4 {\sum }_{i = 1}^{n} {( {A}_{Y , i} {w}_{i} )}^{2} & 4 {\sum }_{i = 1}^{n} {( {A}_{Y , i} {A}_{Z , i} {w}_{i} )}^{2} & 2 {\sum }_{i = 1}^{n} ( {A}_{Y , i} {w}_{i}^{2} ) \\ 4 {\sum }_{i = 1}^{n} {( {A}_{Z , i} {A}_{X , i} {w}_{i} )}^{2} & 4 {\sum }_{i = 1}^{n} {( {A}_{Y , i} {A}_{Z , i} {w}_{i} )}^{2} & 4 {\sum }_{i = 1}^{n} {( {A}_{Z , i} {w}_{i} )}^{2} & 2 {\sum }_{i = 1}^{n} ( {A}_{Z , i} {w}_{i}^{2} ) \\ 2 {\sum }_{i = 1}^{n} ( {A}_{X , i} {w}_{i}^{2} ) & 2 {\sum }_{i = 1}^{n} ( {A}_{Y , i} {w}_{i}^{2} ) & 2 {\sum }_{i = 1}^{n} ( {A}_{Z , i} {w}_{i}^{2} ) & {\sum }_{i = 1}^{n} ( {w}_{i}^{2} )\end{matrix} \vert & ( 13 ) \\ {A}^{T} \cdot W \cdot \overline{M} = \vert \begin{matrix}2 \cdot {\sum }_{i = 1}^{n} ( {A}_{X , i} {w}_{i}^{2} {M}_{i} ) \\ 2 \cdot {\sum }_{i = 1}^{n} ( {A}_{Y , i} {w}_{i}^{2} {M}_{i} ) \\ 2 \cdot {\sum }_{i = 1}^{n} ( {A}_{Z , i} {w}_{i}^{2} {M}_{i} ) \\ {\sum }_{i = 1}^{n} ( {w}_{i}^{2} {M}_{i} )\end{matrix} \vert & ( 14 )\end{matrix}$$

Two more techniques which may be utilized in the process of calibrating the accelerometers are a recursive solution to minimize the data storage required and a scaling method to keep the summation from growing. The scaling method works by dividing the total sum by the number of samples, so as to keep the value of the sum from increasing to the point that it cannot be easily represented in memory. The summation can be stopped if the system determines that it has enough points for a solution. A new summation may be started if the system needs to be recalibrated. The scaling method is equivalent to using a low pass filter.

An example is provided here which combines both the recursive solution and the scaling method, as follows. Let α_{1,2}(n) be a scaled version of the summation term (1,2) of Eq. 13. A technique equivalent to calculating a recursive mean, as in equation (15), is used to give equation (16). All of the elements of the matrices in equations (13) and (14) can be represented similarly. Consequently, equations (13) and (14) can be solved using minimal memory, since only the sum from the 1^{st} to the (n−1)^{th} element is stored in memory for each element, to be combined with the current, n^{th}, term which is determined by current measurements.

$$\begin{matrix} {\overline{x}}_{n} = ( \frac{n - 1}{n} ) \cdot {\overline{x}}_{n - 1} + ( \frac{1}{n} ) \cdot {x}_{n} & ( 15 ) \\ \begin{matrix}{α}_{( 1 , 2 ) , n} = ( \frac{1}{n} ) \cdot 4 {\sum }_{i = 1}^{n} {( {A}_{X , i} {A}_{Y , i} {w}_{i} )}^{2} \\ = ( \frac{n - 1}{n} ) \cdot [ ( \frac{1}{n - 1} ) \cdot 4 {\sum }_{i = 1}^{n - 1} {( {A}_{X , i} {A}_{Y , i} {w}_{i} )}^{2} ] + \\ ( \frac{1}{n} ) \cdot [ 4 \cdot {( {A}_{X , n} {A}_{Y , n} {w}_{n} )}^{2} ] \\ = ( \frac{n - 1}{n} ) \cdot {α}_{( 1 , 2 ) , n - 1} + ( \frac{1}{n} ) \cdot 4 \cdot {( {A}_{X , n} {A}_{Y , n} {w}_{n} )}^{2}\end{matrix} & ( 16 )\end{matrix}$$

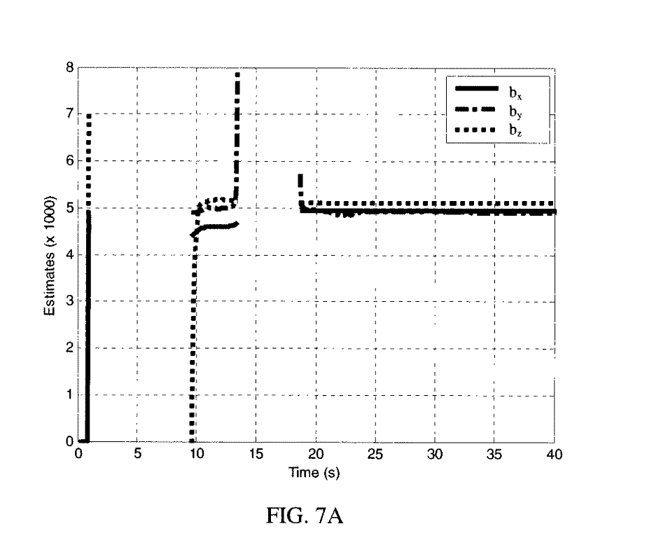

FIG. 5 shows the “Gravity Ellipsoid” which results when the device 100 is fully rotated. In the simplest case, the gravity ellipsoid is a sphere, where the center of the sphere is the bias triplet and the radius is gravity. (Note that the real data shown in FIG. 5 will most likely require estimation of both bias and scaling factors in order to provide a useful calibration—see below.) The axes are in units of levels—described above; there are approximately 8000 levels available in this particular example. The noise data points are provided on a gray scale where black data points indicate low noise data, through white which is high noise data. FIG. 6 shows a resolution of the parameters from the data of FIG. 5, and shows the convergence of the solution of equation (8) using the method described above within about 10 seconds (at 10 Hz data sampling).

A further embodiment of the present invention is the estimation of scaling factors for the accelerometers, in other words, properly estimating the “Gravity Ellipsoid” instead of just assuming a gravity sphere. Equation (17) defines an ellipsoid where Gₓ, G_{y} and G_{z} represent the components of gravity multiplied by a scaling factor for each accelerometer in the triad. Note that when the three accelerometers have the same scaling factor, equation (17) describes a sphere; when the scaling factors are not equal the ellipsoid may be an oblate spheroid, a prolate spheroid or a scalene ellipsoid. Equation (17) may be solved, but creates a slight asymmetry which causes there to be a difference in the quality of the estimates of the scale factors depending on the arrangement of the axes in the equation solution. For example, the solution provided below in equations (18) through (21) is constructed with G_{y} and G, being dependent on Gₓ. This will result in G_{y} and G_{z} having larger errors than Gₓ.

$$\begin{matrix}1 = {( \frac{{A}_{X} - {b}_{X}}{{G}_{X}} )}^{2} + {( \frac{{A}_{Y} - {b}_{Y}}{{G}_{Y}} )}^{2} + {( \frac{{A}_{Z} - {b}_{Z}}{{G}_{Z}} )}^{2} & ( 17 ) \\ {k}_{XY} = \frac{{G}_{X}}{{G}_{Y}} , {k}_{XZ} = \frac{{G}_{X}}{{G}_{Z}} & ( 18 , 19 ) \\ {A}_{X}^{2} = {G}_{X}^{2} + 2 {b}_{X} {A}_{X} - {b}_{X}^{2} - {A}_{Y}^{2} {k}_{XY}^{2} + 2 {b}_{Y} {A}_{Y} {k}_{XY}^{2} - {b}_{Y}^{2} {k}_{XY}^{2} - {A}_{Z}^{2} {k}_{XZ}^{2} + 2 {b}_{Z} {A}_{Z} {k}_{XZ}^{2} - {b}_{Z}^{2} {k}_{XZ}^{2} & ( 20 ) \\ \vert {A}_{X}^{2} \vert = \vert \begin{matrix}2 {A}_{X} & - {A}_{Y}^{2} & 2 {A}_{Y} & - {A}_{Z}^{2} & 2 {A}_{Z} & 1\end{matrix} \vert \cdot \vert \begin{matrix}{b}_{X} \\ {k}_{XY}^{2} \\ {b}_{Y} {k}_{XY}^{2} \\ {k}_{XZ}^{2} \\ {b}_{Z} {k}_{XZ}^{2} \\ {G}_{X}^{2} - {b}_{Z}^{2} {k}_{XZ}^{2} - {b}_{Y}^{2} {k}_{XY} - {b}_{X}^{2}\end{matrix} \vert & ( 21 )\end{matrix}$$

Using the definitions in equations (18) and (19), equation (17) is rearranged to give equations (20) and (21). The solutions for each parameter can be resolved from the estimates resulting from equation (21). The variance of G_{X} will be different from G_{Y} and G_{Z}. Note that G_{X} is equivalent to r_{X} in equation 1, with k_{XY}=k_{X}/k_{Y}.

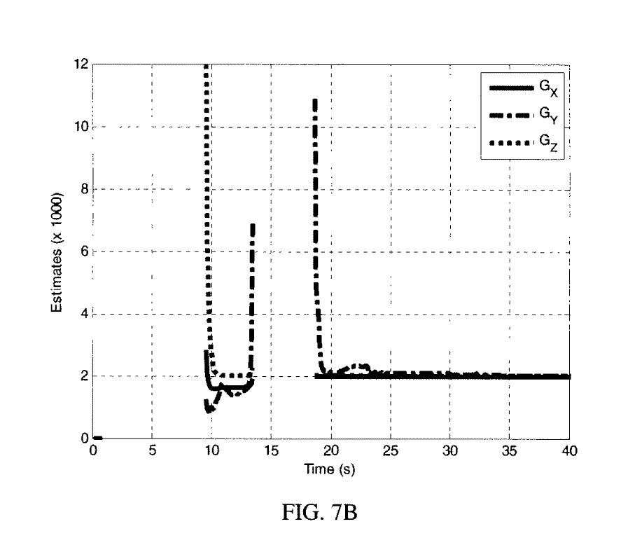

FIGS. 7A and 7B show the convergence of the solution of equation (21) using the method described above. Note that it is in the nature of the method of solving the equations that discontinuities may be seen in the calculated values of the biases and scaling factors prior to convergence of the solution. FIGS. 7A and 7B show a resolution of the parameters from the data of FIG. 5.

The present invention can be further extended to describe less well defined “Gravity Surfaces” in three dimensions. However, for practical purposes these surfaces are approximated to spheroidal or ellipsoidal surfaces for which more convenient mathematical solutions are available, as described above.

Although some methods of the present invention have been described as including complete rotation of the handheld device including the accelerometers which are being calibrated, only partial rotations and similar movements may still result in satisfactory calibration. Instead of generating a gravity ellipsoid, such a movement will result in a partial ellipsoid such as the ellipsoidal caps shown in FIGS. 8A and 8B. The units of the axes are ADC levels and the plots are line segments connecting consecutively collected data points. The data was output by the GPS receiver at 1 Hz and collected by a desktop computer over approximately five minutes. The plots indicate how the GPS receiver moved—the receiver was pitched back and forth several times, rolled left and right, then held at an angle to the vertical and rotated a few times. The overall angular displacement is approximately 20 degrees about two of the three accelerometer axes (pitch and roll in this example). The solution of equation (21) still converged, providing accelerometer scaling factors and biases, for this example of limited data. Similarly, the movement associated with a person removing a handheld device from a pocket and bringing it in front of themselves to view the device may be sufficient to provide calibration of the accelerometers. Furthermore, even movement of a device in a user's pocket due to the user moving about may suffice to provide calibration of the accelerometers.

Accelerometers embedded in a device and calibrated using some embodiments of the present invention may be used to estimate: the pitch and/or roll of the device with respect to the earth; the magnitude and direction of the local gravity vector; horizontal acceleration of the device—useful for navigation applications; and vertical acceleration of the device—useful for pedestrian navigation up and down stairs and elevators, for example. Note that accelerations are measured in units of g—a standard value of gravity, which on the Earth's surface is approximately 9.8 m/s². However, using a gravity table, more accurate estimates of the magnitude of the acceleration may be calculated. The methods of the present invention may be useful for calibration of accelerometers in a wide range of devices including: GPS devices such as a handheld/portable personal navigation device (PND, e.g. from Garmin, TomTom, etc.), a cell phone, iPhone, PDA, handheld or laptop computer, other types of devices with built-in GPS functionality, or any GPS device embedded in tracking applications (e.g. automotive tracking from Trimble, package or fleet management tracking from FedEx, child locator tracking applications etc.). Furthermore, methods of the present invention may be useful for calibration of accelerometers in non-GPS devices—for example, accelerometers are used in devices for vibration/seismic sensing, monitoring of machinery, pedestrian motion, etc.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A method for calibrating an accelerometer without needing to use external assistance signals, said accelerometer having a bias, said bias being a zero offset for measurements by said accelerometer, said method comprising:
moving said accelerometer, wherein the orientation of the axis of said accelerometer changes with respect to the local gravity vector;
collecting accelerometer measurements as said accelerometer is moving; and
calculating said bias;
wherein said accelerometer measurements are primarily due to local gravity.

2. A method as in claim 1, wherein said collecting is periodic.

3. A method as in claim 2, wherein said collecting is at 10 Hz.

4. A method as in claim 1, wherein said collecting includes of the order of 100 measurements.

5. A method as in claim 1, further comprising weighting each of said measurements by an estimated noise power.

6. A method as in claim 1, wherein said accelerometer is a component accelerometer of an accelerometer triad.

7. A method as in claim 6, wherein said calculating includes solving the equation
G²=(A_{X}−b_{X})²+(A_{Y}−b_{Y})²+(A_{Z}−b_{Z})²
wherein Aₓ, A_{y} and A_{z} are measurements for the three component accelerometers of said accelerometer triad, bₓ, b_{y} and b_{z} are corresponding biases, and G is a constant.

8. A method as in claim 1, wherein said solving includes a recursive method.

9. A method as in claim 1, further comprising calculating a scale factor of said accelerometer.

10. A method as in claim 9, wherein said accelerometer is a component accelerometer of an accelerometer triad.

11. A method as in claim 10, wherein said solving includes solving the equation
$$1 = {( \frac{{A}_{X} - {b}_{X}}{{G}_{X}} )}^{2} + {( \frac{{A}_{Y} - {b}_{Y}}{{G}_{Y}} )}^{2} + {( \frac{{A}_{Z} - {b}_{Z}}{{G}_{Z}} )}^{2}$$
wherein Aₓ, A_{y} and A_{z} are measurements for the three component accelerometers of said accelerometer triad, bₓ, b_{y} and b, are corresponding biases, and Gₓ, G_{y} and G, are corresponding scale factors.

12. A method as in claim 1, wherein said moving said accelerometer is rotating said accelerometer.

13. A method as in claim 1, wherein said accelerometer is embedded in a portable device.

14. A method as in claim 13, wherein said moving said accelerometer is a self-calibration process involving no deliberate calibration motions by a user of said portable device.

15. A method as in claim 13, wherein said portable device is a communication device.

16. A method as in claim 13, wherein said portable device is a navigation device.

17. A method as in claim 13, wherein said accelerometer is a component accelerometer of an accelerometer triad, and wherein said self-calibration process involves motion of less than 20 degrees about any of the axes of said accelerometer triad.

18. A method as in claim 13, wherein said accelerometer measurements are due to local gravity and acceleration of said portable device, and wherein said acceleration of said portable device has a magnitude of less than 0.01 times local gravity.

19. A method as in claim 13, wherein said accelerometer measurements are due to local gravity and acceleration of said portable device, and wherein said acceleration of said portable device has a magnitude of less than 0.1 times local gravity.

20. A circuit for calibrating an accelerometer triad without needing to use external assistance signals, each component accelerometer of said accelerometer triad having a bias, said bias being a zero offset for measurements by said component accelerometer, said circuit comprising:
an analog to digital converter for converting analog accelerometer measurements from said accelerometer triad into digital accelerometer measurements;
a power routine processor block for weighting each of said digital accelerometer measurements by an estimated noise power; and
a bias estimate processor block for calculating said biases from weighted digital accelerometer measurements.

21. A circuit as in claim 20, wherein said biases are calculated by solving the equation
G²=(A_{X}−b_{X})+(A_{Y}−b_{Y})²+(A_{Z}−b_{Z})²
wherein Aₓ, A_{y} and A_{z} are measurements for the three component accelerometers of said accelerometer triad, bₓ, b_{y} and b_{z} are corresponding accelerometer biases, and G is a constant.

22. A circuit as in claim 20, wherein said biases are calculated by solving the equation
$$1 = {( \frac{{A}_{X} - {b}_{X}}{{G}_{X}} )}^{2} + {( \frac{{A}_{Y} - {b}_{Y}}{{G}_{Y}} )}^{2} + {( \frac{{A}_{Z} - {b}_{Z}}{{G}_{Z}} )}^{2}$$
wherein Aₓ, A_{y} and A_{z} are measurements for the three component accelerometers of said accelerometer triad, bₓ, b_{y} and b_{z} are corresponding biases, and Gₓ, G_{y} and G, are corresponding scale factors.

23. A circuit as in claim 22, wherein said bias estimate processor block is also for calculating said scale factors.
